(19) United States
(12) Patent Application Publication
(10) Pub. No.: US 2013/0240004 A1
(43) Pub. Date: Sep. 19, 2013

(54) CLEANING SYSTEM FOR SOLAR PANEL

(71) Applicant: TEN-CHEN HO, Tu-Cheng (TW)

(72) Inventor: TEN-CHEN HO, Tu-Cheng (TW)

(73) Assignee: HON HAI PRECISION INDUSTRY CO., LTD., Tu-Cheng (TW)

(21) Appl. No.: 13/561,332

(22) Filed: Jul. 30, 2012

(30) Foreign Application Priority Data
Mar. 16, 2012 (CN) 201210069682.2

(51) Int. Cl. B08B 3/00

(52) U.S. Cl. 134/56 R

(57) ABSTRACT

A cleaning system for a solar panel includes a light emitting element mounted on a battery plate of the solar panel, a photosensitive element mounted on a glass plate of the solar panel, and a control circuit connected to the photosensitive element to receive the light intensity of the light from the light emitting element. The control circuit further compares the light intensity received from the photosensitive element with a preset light intensity. When the light intensity received by the photosensitive element is substantially equal to the preset light intensity, the control circuit controls a switch to disconnect a fluid tank from a nozzle. When the light intensity received by the photosensitive element is less than the preset light intensity, the control circuit controls the switch to connect the fluid tank to the nozzle for releasing a cleaning fluid to clean the glass plate.

### BACKGROUND

1. Technical Field

The present disclosure relates to a system for cleaning a solar panel.

2. Description of Related Art

Nowadays, with the earth resources being depleted day by day, the cost of investment for energy increases significantly. Solar energy has drawn great attention from the energy industry as an alternative source of energy, and now has widespread applications in a variety of fields. However, when a solar panel has been used for a period of time, it becomes dirty and less efficient and so needs to be cleaned, which is inconvenient.

### BRIEF DESCRIPTION OF THE DRAWINGS

Many aspects of the embodiments can be better understood with reference to the following drawings. The components in the drawing are not necessarily drawn to scale, the emphasis instead being placed upon clearly illustrating the principles of the present embodiments. Moreover, in the drawings, like reference numerals designate corresponding parts throughout the several views.

FIG. 1 is a schematic, isometric view of an exemplary embodiment of a cleaning system for solar panels.

FIG. 2 is a block diagram of the cleaning system of FIG. 1.

FIG. 3 is an enlarged view of the circled portion III of FIG. 1.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at least one.

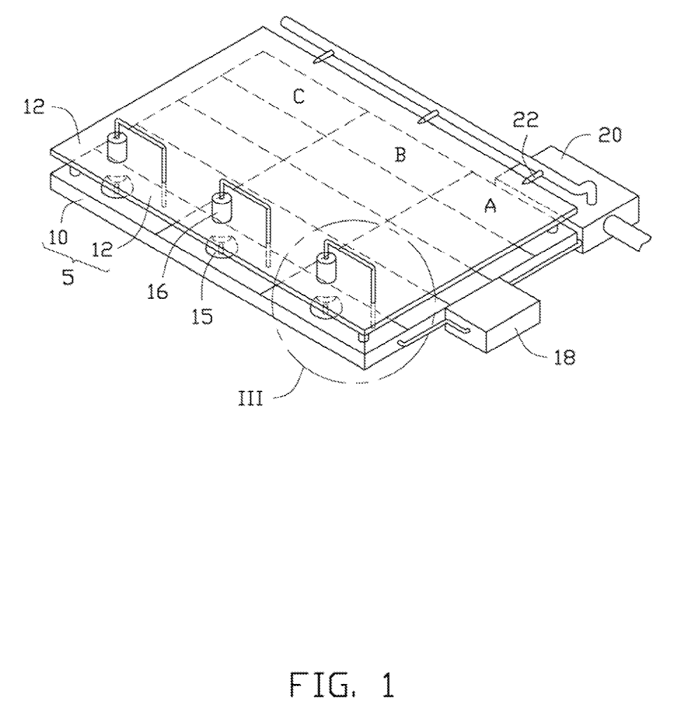

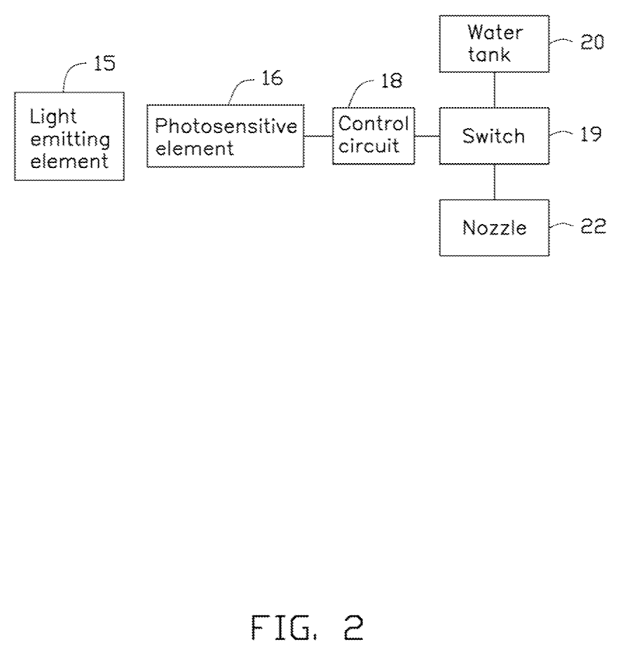

Referring to FIGS. 1 and 2, an exemplary embodiment of a cleaning system for a solar panel 5 is shown. The solar panel 5 includes a battery plate 10 and a glass plate 12. The battery plate 10 collects solar energy and converts the solar energy to electrical energy. The glass plate 12 is mounted above the battery plate 10 for protecting the battery plate 10.

The cleaning system includes a plurality of light emitting elements 15, a plurality of photosensitive elements 16, a control circuit 18, a switch 19, a cleaning fluid tank 20, and a plurality of nozzles 22. In the embodiment, the cleaning system includes three light emitting elements 15, three photosensitive elements 16, and three nozzles 22.

The light emitting elements 15 are mounted on the battery plate 10. The photosensitive elements 16 are mounted on the glass plate 12. Each photosensitive element 16 corresponds to a light emitting element 15, for sensing light intensity of the light from the corresponding light emitting element 15. The photosensitive elements 16 are connected to the control circuit 18, for transmitting the sensed light intensity to the control circuit 18. The control circuit 18 is further connected to the switch 19. The switch 19 is connected between the fluid tank 20 and the nozzles 22. The control circuit 18 controls the switch 19 to connect or disconnect the fluid tank 20 to or from the nozzles 22.

As shown in FIG. 1, the three light emitting elements 15 are respectively located under regions A, B, and C of the glass plate 12. Cleaning regions of the three nozzles 22 respectively correspond to the regions A, B, and C of the glass plate 12.

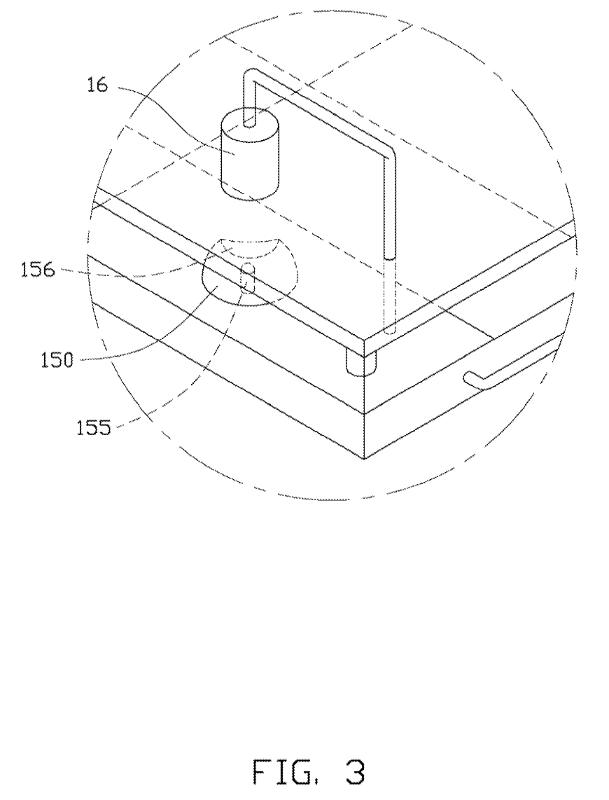

Referring to FIG. 3, each light emitting element 15 includes a base 150 mounted on the battery plate 12, and a light emitting diode 155. The base 150 is hemispherical and defines a hole 156 having a blind top end. The light emitting diode 155 is mounted on a bottom end of the hole 156. The base 150 is made of opaque material.

In use, the light emitting diode 155 is activated. The photosensitive element 16 receives the light from the light emitting diode 155 through the glass plate 12 and obtains a light intensity of the light. The light intensity is transmitted to the control circuit 18. The control circuit 18 compares the received light intensity with a preset light intensity. The preset light intensity is equal to the light intensity of the light directly received by the photosensitive element 16 without the glass plate 12. When a region, such as region A, of the glass plate 12 is clean, the light intensity of the light received by the corresponding photosensitive element 16 is almost equal to the preset light intensity. In this condition, the control circuit 18 determines that the region A of the glass plate 12 is clean, and need not be cleaned. The control circuit 18 controls the switch 19 to disconnect the fluid tank 20 from the nozzle 22 corresponding to the region A of the glass plate 12.

When any, such as region B, of the glass plate 12 is not clean, the light intensity of the light received by the corresponding photosensitive element 16 is less than the preset light intensity. In this condition, the control circuit 18 determines that the region B of the glass plate 12 needs to be cleaned. The control circuit 18 controls the switch 19 to connect the fluid tank 20 to the nozzle 22 corresponding to the region B of the glass plate 12. The nozzle 22 releases a cleaning fluid to clean the region B of the glass plate 12.

The foregoing description of the exemplary embodiments of the disclosure has been presented only for the purposes of illustration and description and is not intended to be exhaustive or to limit the disclosure to the precise forms disclosed. Many modifications and variations are possible in the light of everything above. The embodiments were chosen and described in order to explain the principles of the disclosure and their practical application so as to enable others of ordinary skill in the art to utilize the disclosure and various embodiments with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A cleaning system for a solar panel, the solar panel comprising a battery plate and a glass plate mounted above the battery plate, the cleaning system comprising:
a light emitting element mounted on the battery plate, and to emit light;
a photosensitive element mounted on the glass plate, and to receive light from the light emitting element through the glass plate and obtaining a light intensity of the light;
a control circuit connected to the photosensitive element, and to receive the light intensity of the light from the light emitting element and comparing the light intensity received from the photosensitive element with a preset light intensity, wherein the preset light intensity is equal to a light intensity of the light directly received by the photosensitive element without the glass plate;
a fluid tank;
a nozzle; and
a switch connected between the fluid tank and the nozzle, wherein the control circuit controls the switch to connect the fluid tank to the nozzle in response to the light intensity received by the photosensitive element being less than the preset light intensity, and controls the switch to disconnect the fluid tank from the nozzle in response to the light intensity received by the photosensitive element substantially being equal to the preset light intensity.

2. The cleaning system of claim 1, wherein the light emitting element comprises a base mounted on the battery plate and a light emitting diode, the base defines a hole, the light emitting diode is mounted in the hole, the base is made of opaque material.

3. The cleaning system of claim 2, wherein the base is hemispherical, the hole has a blind top end, the light emitting diode is mounted in a bottom end of the hole.

4. A cleaning system for a solar panel, the solar panel comprising a battery plate and a glass plate mounted above the battery plate, the cleaning system comprising:
a plurality of light emitting elements mounted at different areas on the battery plate;
a plurality of photosensitive elements mounted at different areas of the glass plate, the photosensitive elements having a same number with the light emitting elements and respectively corresponding to the light emitting elements, wherein each photosensitive element receives light from a corresponding light emitting element through the glass plate and obtains a light intensity of the light;
a control circuit connected to the photosensitive elements, and receiving the light intensity of the light from the light emitting elements and comparing the light intensity received from the photosensitive elements with a preset light intensity, wherein the preset light intensity is equal to a light intensity of the light directly received by the photosensitive element without the glass plate;
a fluid tank;
a plurality of nozzles; and
a switch connected between the fluid tank and the nozzles, wherein the control circuit controls the switch to connect the fluid to the nozzles in response to the light intensity received by the corresponding photosensitive elements being less than the preset light intensity, and controls the switch to disconnect the fluid tank from the corresponding nozzles in response to the light intensity received by the corresponding photosensitive elements being substantially equal to the preset light intensity.

5. The cleaning system of claim 4, wherein each light emitting element comprises a base and a light emitting diode, the base defines a hole, the light emitting diode is mounted in the hole, the base is made of opaque material.

6. The cleaning system of claim 5, wherein the base is hemispherical, the hole has a blind top end, the light emitting diode is mounted in a bottom end of the hole.
